(19) United States
(12) Patent Application Publication
(10) Pub. No.: US 2015/0185352 A1
(43) Pub. Date: Jul. 2, 2015

(54) METAL DETECTING SHOE

(71) Applicant: Amil Ambalangodage Jayasuriya, Bloomfield, MI (US)

(72) Inventor: Amil Ambalangodage Jayasuriya, Bloomfield, MI (US)

(21) Appl. No.: 14/146,701

(22) Filed: Jan. 2, 2014

(51) Int. Cl. G01V 3/165; G01V 3/08; F41H 11/136

(52) U.S. Cl. CPC G01V 3/165; F41H 11/136; G01V 3/08

(57) ABSTRACT

A metal detecting system is designed and packaged into footwear such that it can be worn on one or both legs in lieu of carrying a hand held metal detecting device. The metal detecting hardware can be installed in its entirety inside the sole and on the shoe. In other cases detection coils, sensors, buzzers and LEDs can be installed inside the sole and on the shoe while other components of the detection system can be packaged in an external pouch to be carried by the wearer of the metal detecting shoes. Furthermore the buzzers and LEDs may be attached to the shoe as well as to the external electronic module when the module is designed to be held away from the shoe. In the event that a buried metal object is found along the path of the shoe swinging in the air while walking, the buzzers will sound and the LEDs will illuminate to notify/alarm the user, thus fulfilling its purpose. The strength, buried depth and variety of metals that can be detected depend on the electronics, coils and sensors used in the metal detecting shoe system. When there are no other means available to detect landmines and UXOs, this invention provides a practical method for the people living in these dangerous areas to detect buried explosive devices and avoid injury/death while giving them mobility and free hands to carry on daily work. This invention also provides a convenient method of metal detection for treasure hunters and as a toy for children to wear metal detecting shoes instead of hand held devices that are inconvenient and attract attention from passers-by.

### TECHNICAL FIELD

The present invention relates to a shoe that can be worn to detect hidden metal objects. The metal detecting system of the shoe becomes convenient, durable, and effective in certain situations such as detecting buried landmines in war zones or in the case of treasure hunting, or for use by children as a toy.

### BACKGROUND

### Area of Application 1: Landmine Detection

It is known that landmines have become a new era of warfare in many parts of the globe. Being relatively less expensive and effective compared to many other weapons landmines have caught the eye of countless organizations, from governments to rebel organizations, as one of the ideal methods of defense and aggression. Furthermore, landmines have become one of the most indiscriminate weapons that exist today. Their catastrophic detonations have claimed thousands of lives, devastating injuries and trauma to innocent civilians and soldiers alike.

An estimated 80 million landmines are still buried worldwide and at least 84 countries are affected by landmines. More than 200,000 square kilometers of the world's surface is contaminated with landmines. That is the equivalent to half of the state of California. It is also estimated that 54 countries have approximately 180 million antipersonnel mines stockpiled [http://www.landminesurvivors.org/what_landmines.php]. According to a recent UNICEF report, landmines still kill or maim 15,000 to 20,000 people a year [http://www.unicef.org/protection/usa_{—}39306.html]. The mine injury caused by stepping on a buried blast-type mine, is the most severe and it generally involves the loss of at least one body part, with traumatic harm to other body parts. As the landmine tears the foot or leg from the rest of the body, it shoots parts of the earth—dirt, rocks, grass and even body parts into the victim. There are currently an estimated 300,000 people who have survived landmine blasts. However, there are hundreds of millions of people worldwide, whose family members and/or communities have been devastated by this inhumane and indiscriminate weapon. Over 70% of landmine victims are civilian and nearly one-third of the civilian victims are children. Over 50% of mine victims die and fewer than 10% of the victims have access to proper medical care and rehabilitation [http://www.landminesurvivors.org/news_article.php?id=205].

De-mining is a very costly and slow process that cannot reach every global conflict zone that infested with anti-personnel mines and explosive devices. Weapons that cost as little as $3 each to manufacture can cost up to $1,000 to remove and it may take a skilled expert an entire day just to clear by hand 20-50 square meters of mine-contaminated land [http://www.unicef.org/graca/mines.htm]. Furthermore, it costs somewhere between $100 and $3,000 to provide an artificial limb to a survivor. On average, these must be replaced every three to five years for adults, and every six months for children [http://www.landminesurvivors.org/what_landmines.php].

Landmines and other explosive devices contain some metal parts and can be detected by various metal detecting techniques. When there is no other landmine detection method or de-mining is available what is left for the people living in the mine infested areas is unfortunate and to accidentally step on them and lose limbs or lives. Furthermore, carrying some kind of handheld metal detector device is inconvenient and impractical for these people who need free hands to attend their daily work and carry items. Instead, if there is an affordable and convenient metal detection device that needs not to be carried by hand would be an attractive alternative for those who live in such danger zones.

The presented metal detection systems integrated in a shoe are an alternative self-protection method for war torn areas infested with mines and other explosive devices. It also provides cover to the feet and protection against day-to-day injury that may cause by working in a rural setting. Though this device will not help to eradicated existing active landmines and other UXO's it may serve as an affordable and easy to use method of protection for the civilians and soldiers in these regions to prevent further casualty.

### Area of Application 2: Treasure Hunting and as a Toy

This invention also has a potential to apply in an entirely different field altogether. Amidst the multitudes of treasure hunters, hobbyists and children that roam the beaches, woods, and ancient sites this tool would be much appreciated. Thousands scour the beaches each year in hopes of finding items as simple as a sardine can to precious gold. For the casual treasure hunter to even the avid explorer having this tool would be a great addition to their arsenal. Since there is no visible hand held device, Metal detecting shoes are convenient to use and draw less attention from the passersby. Instead of leaving the site with a hunched back or weary arms all that a user must do with the portable metal detecting shoe is walk around wearing them and wait for a signal. The metal detector market is a fairly large one and this invention would catch the eye of many enthusiastic hunters.

### SUMMARY OF THE INVENTION

This invention presents an alternative arrangement to the known handheld standard metal detector. It is optimal due to increased portability, convenience and being less noticeable to an outside observer. This invention discloses a method to integrate metal detection capabilities into a regular shoe. According to the present invention the electromagnetic coils alone or in combination with ground penetrating radar sensors capable of detecting metal are placed, either on or within, or the underside of the shoe. The design and manufacture techniques of electronics, coils and sensors determine the extent of detection power resulting in increased/decreased range and type of metal objects it can detect.

The coils are placed inside the sole of the shoe while electronics can be placed inside the shoe or packaged in an outside pouch. These components are best contained within the sole of the shoe to prevent damage. In addition, the ground penetrating radar sensors may be installed at the side or back of the shoe. Electronic circuitry can be packaged within the shoe or externally in a pouch that can be carried as a belt pouch or by other means. Connected to the circuit is a dial for sensitivity adjustment with a turn switch that is used to turn the power on and calibrate the system. As different environments require differing calibration sensitivities, the dial is used to adjust the sensitivity to optimal setting that suit to the soil and environment.

A dry cell type battery that provides power to the electronics can be packaged within, on, or outside the shoe. The type of battery used is subject to change depending on lifespan and durability. Alternate methods of power from recharging by a wall outlet, solar power or other means can be accommodated.

To alarm the user in the event of detection of metal, a sound and light signal have been added to the design, though may or may not be used simultaneously. One or more LEDs (light emitting diodes) of unspecified color are attached to the exterior of the shoe allowing the wearer to be alerted visually. One or more buzzers are also connected, either in or atop, the shoe to get the attention of the wearer. When a metal detecting shoe wearer takes a step if the buzzers or LEDs or both are activated that suggests metal is present under the shoe. Non-active buzzers and/or LEDs suggest that no metal has been detected by the apparatus.

Furthermore, in order to prolong the battery life, a momentary push-break (push-off) switch is attached onto the underside of the shoe that shuts off the metal detecting electronics when the foot with metal detecting shoe is on the ground. This ramp type design or a push type momentary switch turns the circuit on when the leg is in swinging phase of the walk and the shoe is not on the ground, ergo in the air. This means when the switch is not pushed or pressured then detection shall commence. This allows the shoe to detect surrounding metal prior to touching the ground. If it is in a landmine buried area wearer shall walk with caution and if the sound and/or light alarm detecting metal it is advised to take the step back and try a safe alternate place to step on and continue the walk or turn back. The wearer may place some sort of a sign to indicate others something is buried around that location. If it a treasure hunter, hobbyist or child playing, then the wearer can dig the ground where the alarm sounds or lights up to investigate what it is buried under.

Various methods of assembly are permitted so long as the shoe is capable of detection and capable of relaying such detections to the user. Other advantages and features of the invention will become apparent when viewed in light of the detailed descriptions of the preferred embodiments when taken in conjunction with the attached drawings.

### BRIEF DESCRIPTION OF THE DRAWINGS

For a better understanding of this invention, reference should now be made to the embodiments illustrated in greater details in the accompanying drawings. The embodiments set forth herein are not intended to limit or restrict the claims to the precise forms and configurations shown in the drawings and disclosed in the detailed description and the specifications of this invention.

FIG. 1 is a view of a person's stages of walk to illustrate the swing phase of the right foot and shoe

FIG. 2 is a view of magnetic field generated by a metal detecting shoe on the right foot when the foot is in the swing phase

FIG. 3 is a view of a metal detecting shoe with a buzzer and LCDs

FIG. 4 is a view of the electronics components of a metal detecting device attached to the sole of a shoe

FIG. 5 is a view of the metal detecting shoe with a battery inside a pouch attached to the backside of the shoe

FIG. 6 is a view of the metal detecting shoe with a jack inside the shoe to use with a battery charger

FIG. 7 is a view of metal detecting shoes with externally mounted electronic module inside a waist pouch when worn by a person

FIG. 8 is a view of externally mounted electronic module and optional display monitor inside a waist pouch

FIG. 9 is a view metal detecting devices mounted on to an overshoe

FIG. 10 is a view of an overshoe with metal detecting device showing bottom of the sole

### SPECIFICATIONS

### General Description

This invention displays a shoe designed to detect metal objects buried in the ground when worn and placed over buried objects prior to stepping on them. Such objects include anti-personnel (AP) landmines, unexploded ordinances (UXO's), coins, metal pipes and other metal objects etc. that exist buried a few inches underneath the ground surface. The metal detection device that integrated into a shoe as disclosed in this invention may be used by individuals living in and around war zones to reduce injury and death as a result of stepping on the buried explosive devices when there is no other option is available to detect them. This invention describes a hands-free detection device that allows the users to perform normal day-to-day activities while walking and working in suspected AP minefields. This invention also provides a metal detecting device for hobbyists and children who are interested in treasure hunting, allowing them to search without carrying a visible handheld detector. The metal detectors installed on the shoes can be worn on both feet or on one foot as an option in the manufacturing process of pairs of shoes. All the components that comprise a metal detector can be designed and built to be packaged within the shoe including a power source (battery), alarms, switches and sensitivity control dials or knobs. It can also be designed to have some components such as coils and radar sensors attached to the shoe while other components such as electronics are packaged outside the shoe to be attached to the waist belt, garment pockets, or other means as long as an electrical connection exists between the components. Overall the metal detecting shoe may have components such as insulated magnetic wire coils, electronic module, battery, buzzer(s), LED light(s), momentary push-break switch, control dial with on-off switch mounted within or outside the shoe. The metal detecting shoe must be made waterproof, durable and comfortable. The battery can be either replaceable or rechargeable by an external power source such as wall current, or other sources such as solar power. Advanced models may have an optional display outside the shoe attached to a waist belt pouch. The system can be designed to be packaged in any shoe or boot that provides sufficient space in its sole and heel so that some, if not all, of the components of the metal detector are placed within the sole. It can also be fitted with little or no modifications into any other type of footwear that provides the space needed to accommodate the whole or parts of the metal detection hardware.

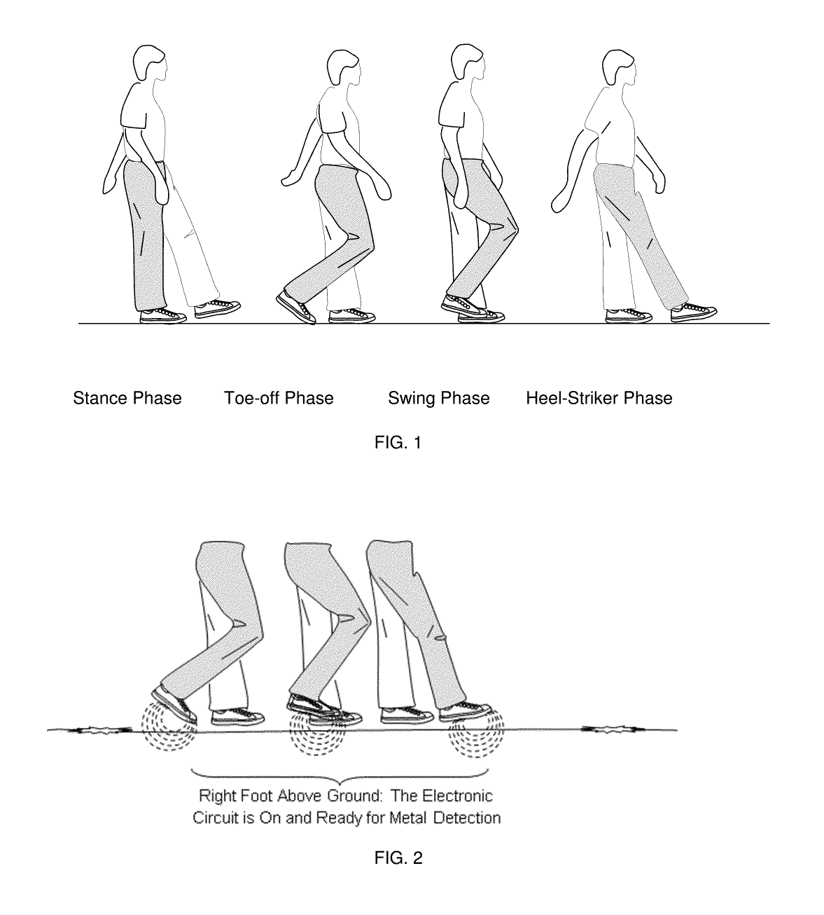

The human walk comprises of 4 stages showing when and how the legs are moved—Stance phase, toe-off phase, swing phase and heel-striker phase as shown in the FIG. 1. The swing phase of the leg motion starts when the toe is lifted ending the ground contact of the feet and ends when the heel strikes starting a next ground contact of the feet in a forward step. In the case of walking in areas that is known to have buried AP mines, a person has a choice to make on where to put his next step. This choice can be sometimes lethal or change the whole life of a person with loss of limbs and injuries if accidentally stepped on a buried AP mine. In such a situation any assistance to detecting at least some of these AP mines could save lives and reduce lifelong injury.

The operation of a metal detector shoe is easy. While walking, the wearer of the metal detecting shoe(s) will hold a metal detecting shoe slightly above the ground and away from any visible metal objects such that the momentary push-break switch is not in contact with the ground. To illustrate the operation with a very common type of metal detecting technology, the user turns the sensitivity dial to switch the power on. At this point, the buzzer will sound and the LEDs will light up. Continue turning the sensitivity dial slowly until the buzzing stops and LED light disappear. The sensitivity dial should not turn anymore soon after buzzing and LED light diminish since the optimal sensing has been established at this moment under the current soil and environment conditions. Follow this procedure to achieve the optimal sensitivity setting for the other shoe as well, if the metal detection systems are available on both shoes. When the wearer is standing with a metal detecting shoe touching the ground, the momentary push-break switch turns off the electronics and cannot detect any metal. While walking, when a metal detecting shoe swings above the ground, the momentary push-break switch turns on the system momentarily and sends electromagnetic waves and (radar signals if available) towards the ground as shown in FIG. 2. The magnetic field that penetrated from the shoe into the ground generates an opposing weak magnetic field around a conducting metal object buried in the ground. The change in magnetic field or oscillating frequency due to the generated opposing magnetic field from the hidden metal object can be detected by the electronics of the metal detecting device. The buzzers will sound and LEDs will light up once any metal buried under the ground is detected along its swinging path. The outlined general operating procedure applies to the Embodiments presented below.

### Description of Embodiment 1

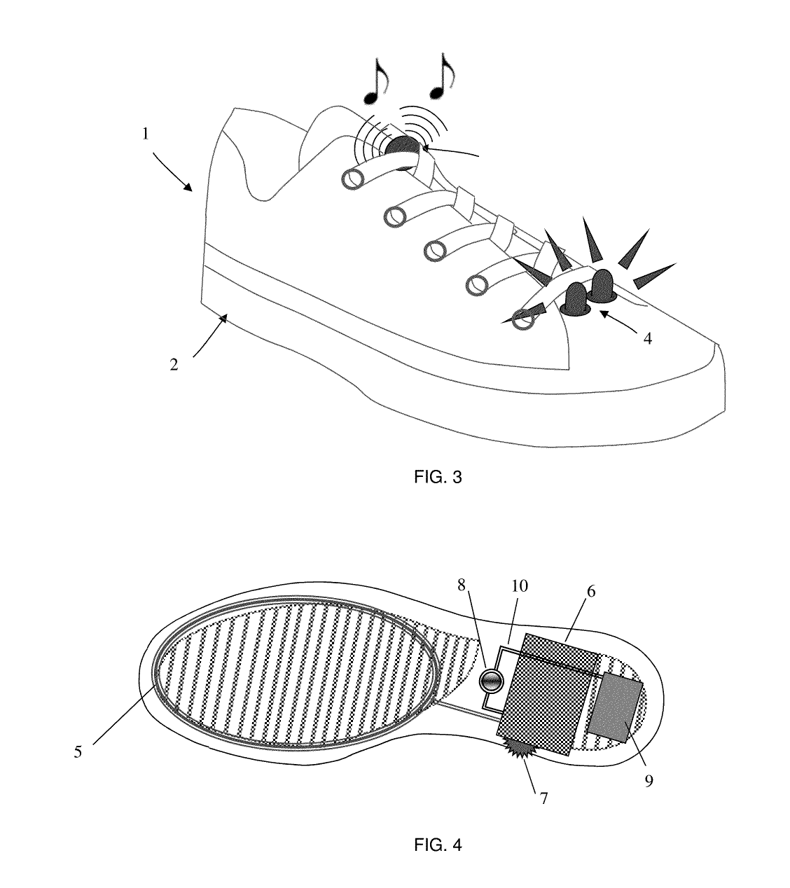

The Embodiment 1 describes a method of making a metal detecting shoe. In the embodiment 1, all the components of the metal detecting device are packaged within the shoe 1 as shown in FIG. 3 and FIG. 4. The key components of the metal detecting system are packaged within the sole 2 of the shoe 1. One or more buzzers 3 and LEDs 4 are mounted to the upper part of the shoe 1. The insulated wire coils 5 used in electromagnetic field generation and field changes detection are placed in the frontal (toe) area of the shoe's sole 2. Similarly, the electronic module 6 is positioned in the heel area of the sole 2. The electronic module 6 comprises of an adjustable sensitivity control dial with an on-off switch 7 and also connected to a momentary push-break switch 8. The power source 9 (a regular dry cell battery, solar power, rechargeable or similar power source) is packaged in the heel area of the sole 2. A connecting wire 10 from the battery to the electronics circuit 6 is routed through the momentary push-break switch 8. In the case of both feet are equipped with metal detecting shoes, the momentary push-break switch 8 on the shoe 1 of the swinging leg will allow only its metal detector to turn the power on while the other metal detector shoe on the standing leg has its power turned off.

The momentary push-break switch 8 is mounted to the bottom of the sole 2 such that when the bottom of the sole 2 is in contact with the ground thee electromagnetic circuit inside the electronic module 6 is turned off to save battery power. When the foot with metal detecting shoe is above the ground and swinging in the air during walk its circuit is turned on and is ready to detect metal objects buried a few inches below the ground along the trajectory of the shoe 1. The magnetic field in the coil 5 generates a weak magnetic field around the hidden conducting metal object. The change in magnetic field or oscillating frequency due to the generated magnetic field from the hidden metal object can be detected by the electronic module 6 and produce sound in the buzzers 3 and the LEDs 4 to flash. The coil 5 can be made of one or two coils based on the detection technology used in the electronic module 6.

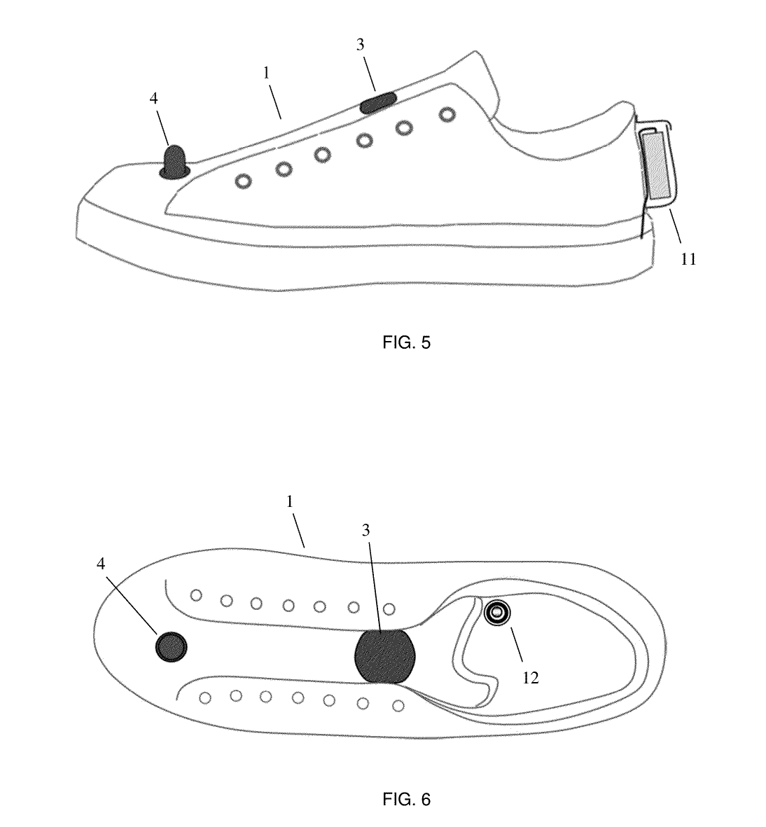

The power source 9 may be placed inside a pouch 11 that is attached to the outer back side of the shoe 1 as shown in FIG. 5. Furthermore, to facilitate the use of optional rechargeable type batteries a recharging jack 12 may be mounted inside the shoe 1 as shown in FIG. 4.

Embodiment 1 of this invention follow the same trends of durability and design options shown in the general description section above such as being waterproof. The metal detection technology and methods described in this invention can be used with various types of footwear and being worn on either one or both feet. Any advanced electronics, coils and sensor technologies that will enhance the metal detection capability are permitted.

### Description of Embodiment 2

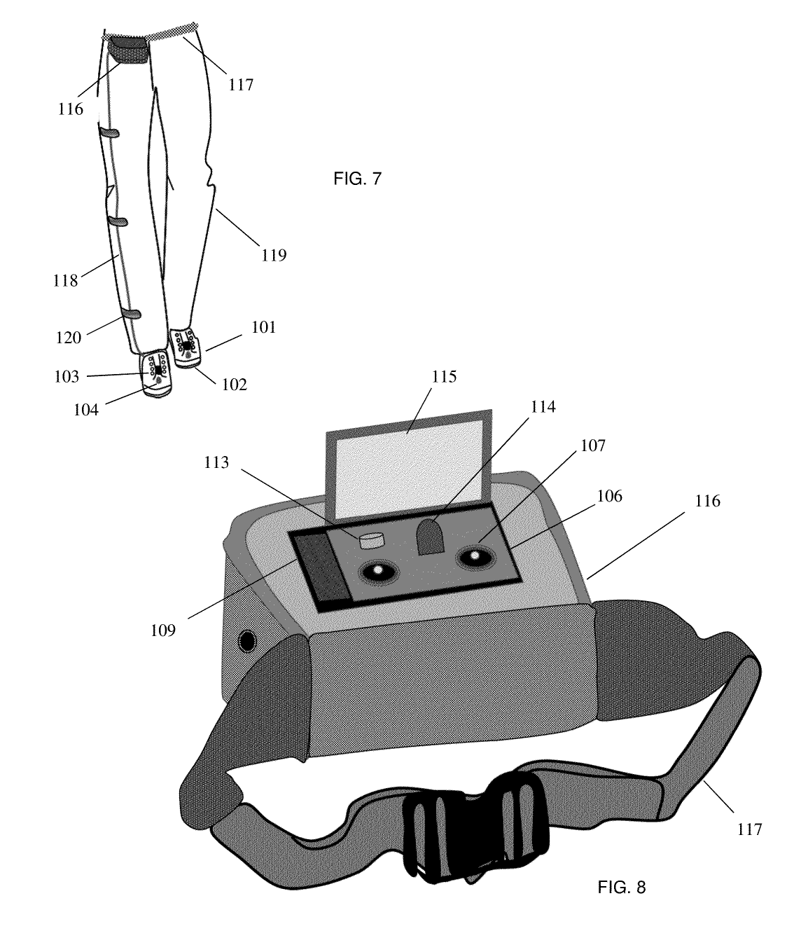

Embodiment 2 of this invention illustrates a metal detecting system of which the metal detecting device is packaged partially within the shoe 101 while other components are packaged outside the shoe 101 as shown in FIG. 7 and FIG. 8. The external electronic module 106 is packaged in a separate pouch 116 that can be worn at the waist level attached to a belt 117 or other means. The wire coils 5 used in electromagnetic field generation and field changes detection are packaged inside sole 102 similar to the way described in Embodiment 1. An outside wire 118 connects the coils 5 inside the sole 102 and the external electronic module 106. The electronic circuitry, sensitivity controls 107, battery 109, buzzer 113, LEDs 114 and a display screen 115, are packaged within the electronic module 106 in a desirable arrangement. The battery 109 can be either dry cell or rechargeable nature. The monitor screen 115 is optional and may display metal detection capability and process. Other methods of power may be used such as solar power. The external electronic module 106 is connected to metal detecting shoe 101 by a wire cable 118 that may be connected via jacks (not shown) at both ends of the wire 118 for easy assembly and disassembly. A momentary push-break switch 8 as described in Embodiment 1 is mounted to the bottom of the sole 102 such that when the shoe 101 is in contact with the ground the electronic circuit is turned off to save battery power. While walking wearing metal detecting shoes of the Embodiment 2 and when a foot is swinging above the ground, the electronic circuit is turned on and ready to detect metal that buried a few inches in the ground along swinging trajectory of the foot.

As shown in FIG. 7, to accommodate the electronic module and/or other equipment being separate from the metal detecting shoe 101, connecting wires 118 may run outside garments and can be attached to the pants 119 by an appropriate means such as Velcro straps 120. The external electronic module 106 may be attached to a garment pocket or carried by other means. The external electronic module 106 may also be carried by shoulder straps or over the neck by a flexible belt. The metal detecting shoe 101 may be equipped with additional buzzers 103 and/or LEDs 104 attached to the shoe 101 itself. In the case both shoes are equipped with detecting metal, the connecting wires 118 that run from both shoes 101 to one external module 106 are connected via jacks (not shown) on the external electronic module 106. In this case, the detecting coils on each shoe 101 may be controlled by two different sensitivity dials 107 that are designed to tune the circuitry inside the electronic module 106. For metal detecting shoes 101 to be worn on both feet, the external electronic module 106 may be designed such that the momentary push-break switch 8 on the shoe 101 of the swinging leg will allow only its metal detecting circuit to power on while the circuit connecting to the other metal detecting shoe 101 on the standing leg has its power turned off.

The metal detecting shoe 101 can be designed to carry a multitude of other metal detecting sensors apart from electromagnetic coils, such as ground penetrating radar sensors, which can be attached externally to the base of the shoe 101. These additional sensors along with advanced electronics and display monitors can enhance the metal detection capability described in this invention. Embodiment 2 follows the same trends of durability and design options shown in the general description section such as being waterproof, can be applied to various types of footwear and being worn on either one foot or both feet. Any advanced electronics, additional sensors and the information on the visual display of Embodiment 2 that will enhance the metal detection capability are permitted.

### Description of Embodiment 3

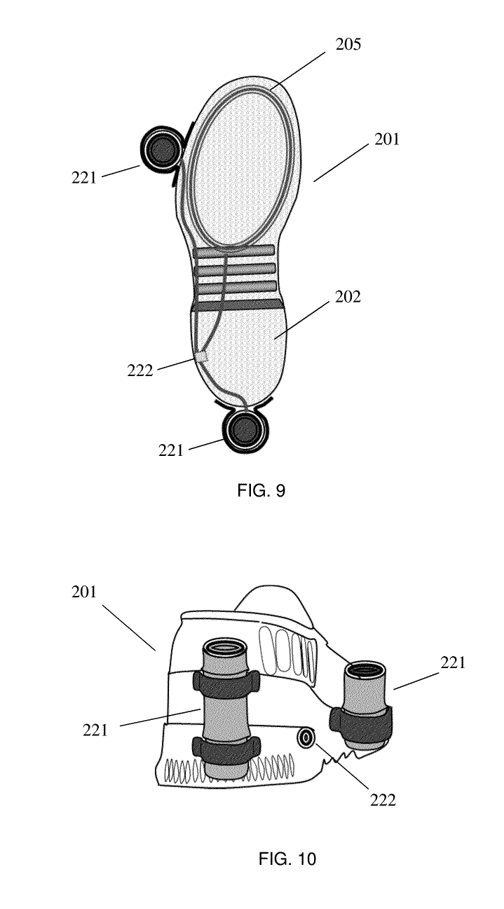

In Embodiment 3 of this invention the metal detecting device is packaged partially or fully within an overshoe 201 or similar add-on shoe covering for easy attachment and removal from a conventional shoe. FIG. 9 and FIG. 10 illustrate how key components of metal detector can be packaged to an overshoe 201. The insulated wire coils 205 used for generating the electromagnetic field and field change detection are packaged covering a part or the entirety of the sole 202 of the overshoe 201. In addition to the detection coils 205 other detection techniques such as ground penetrating radar sensors 221 can be attached to the exterior sides of the overshoe 201. The detection devices may be routed through a common junction box 222 to an appropriate electronic module.

If all the metal detector parts are packaged within the sole 202 of the overshoe 201 then the descriptions of Embodiment 1 applies to Embodiment 3. Should only some of the metal detector parts be packaged within the overshoe 201 and the rest is packaged externally then the description of Embodiment 2 applies to Embodiment 3. Any advanced electronics, additional sensors and the information on the visual display of Embodiment 3 that will enhance the metal detection capability of the overshoe 201 are permitted. The overshoe 201 may be manufactured in multiple styles in order to better suit it to various terrains (e.g. increased traction).

What is claimed is:

1. A metal detecting shoe comprising:
insulated wire coils for electromagnetic field generation, and field changes detection packaged inside the frontal (toe) area of the sole of the shoe.
an electronic module packaged in the heel area of the sole.
a momentary push-break switch mounted to the bottom of the such that when the shoe is in contact with the ground the power to the circuit is off and when the shoe is lifted from ground the circuit powers on.
a sensitivity control dial or regulator with an on-off switch within or outside a shoe.
a power source (battery) packaged in the heel area of the sole or alternatively, packaged inside a pouch that is attached to the outer upper body of the shoe. The battery may be replaceable or rechargeable by wall current or other energy sources such as solar power. With a rechargeable battery a recharging jack is installed inside the shoe.
buzzer(s) and LED(s) attached to the shoe such that sound can be heard and the light can be seen when a metal detection is made.
waterproof components and assembly so that its electronics and battery can be protected by a waterproof design. This allows the metal detecting shoe to be worn during rain.

2. The apparatus in claim 1 can be designed to package inside any shoe, boot and other footwear that has sufficient space in its sole and heel to package the intended all or some of the components of the metal detector.

3. The apparatus in claim 1 is to detect metal objects buried in the ground when it was worn and placed over and before stepping on the buried metal objects such as anti-personnel (AP) landmines, coins and other conducting metal objects. The metal detecting device can be installed on one or both shoes such that the wearer can detect buried metal objects by one foot or both feet.

4. The apparatus in claim 1 is a hands-free metal detection device attached to shoes allowing to carry on day-to-day life activities without holding a portable handheld metal detector while walking and working in areas with suspected AP mines or use during treasure hunting in beaches and other places.

5. A metal detecting shoe device comprising:
insulated wire coils for electromagnetic field generation, and field changes detection packaged inside the frontal (toe) area of the sole of the shoe.
an electronic module packaged outside the shoe and in a separate pouch that can be worn at the waist level with a belt pouch or attached to a belt at the waist level. The electronic module may also be packaged in a separate pouch attached to shoulder straps or over the neck by a flexible belt
a momentary push-break switch mounted to the bottom of the such that when the shoe is in contact with the ground the power to the circuit is off and when the shoe is lifted from ground the circuit powers on.
a sensitivity control dial or regulator with an on-off switch attached to the control module that is packaged outside the shoe.
a power source (battery) attached to the control module that is packaged outside the shoe and a recharging jack in the case of the battery is rechargeable.
buzzer(s), and LED(s) attached to the control module that is packaged outside the shoe.
An optional display monitor attached to the control module that is packaged outside the shoe.
waterproof components and assembly so that its electronics and battery can be protected by a waterproof design. This allows the metal detecting shoe to be worn during rain.
a connecting wire to connect the coils in the shoe and the electronic module in the external pouch via connector jacks and Velcro type straps to secure the connecting wire to the outer garment of the wearer.

6. The apparatus in claim 5 can be worn as a single unit on one foot or two separate units on both feet. In the case of both feet are having metal detector shoes, the coils inside both shoes are connected to a single external electronic module via connecting wires.

7. The apparatus in claim 5 can be designed to carry not only the electromagnetic coils but other types of metal detecting sensors such as ground-penetrating radar sensors attached to the base of the shoe externally. Furthermore, advanced electronics and additional sensing can be incorporated to enhance the metal detection capability.

8. A metal detecting device comprising:
an overshoe with some of the components of the metal detecting device attached which is easy to put-on and remove from a regular shoe.
insulated wire coils for electromagnetic field generation, and field changes detection packaged inside the frontal (toe) area of the sole of the overshoe.
an electronic module packaged outside the overshoe and in a separate pouch that can be worn at the waist level with a belt pouch or attached to a belt at the waist level. The electronic module may also be packaged in a separate pouch attached to shoulder straps or over the neck by a flexible belt
a momentary push-break switch mounted to the bottom of the such that when the overshoe is in contact with the ground the power to the circuit is off and when the overshoe is lifted from ground the circuit powers on.
a sensitivity control dial or regulator with an on-off switch attached to the control module that is packaged outside the overshoe.
a power source (battery) attached to the control module that is packaged outside the overshoe and a recharging jack in the case of the battery is rechargeable.
buzzer(s), and LED(s) attached to the control module that is packaged outside the overshoe.
An optional display monitor attached to the control module that is packaged outside the overshoe.
waterproof components and assembly so that its electronics and battery can be protected by a waterproof design. This allows the metal detecting overshoe to be worn during rain.
a connecting wire to connect the coils in the overshoe and the electronic module in the external pouch via connector jacks and Velcro type straps to secure the connecting wire to the outer garment of the wearer.

9. The apparatus in claim 8 can be worn as a single unit on one foot or two separate units on both feet. In the case of both feet are having metal detector shoes, the coils inside both shoes are connected to a single external electronic module via connecting wires.

10. The apparatus in claim 8 can be designed to carry not only the electromagnetic coils but other types of metal detecting sensors such as ground-penetrating radar sensors attached to the base of the shoe externally. Furthermore, advanced electronics and additional sensing can be incorporated to enhance the metal detection capability.

11. The apparatus in claim 8 may be designed such that all the components of the metal detecting device are attached to the overshoe similar to the method described in claim 1.
